(19) United States
(12) Patent Application Publication
(10) Pub. No.: US 2017/0091860 A1
(43) Pub. Date: Mar. 30, 2017

(54) METHOD AND SYSTEM FOR PERFORMING AN ACTION IN A BRANCHLESS BANKING ENVIRONMENT

(71) Applicant: MASTERCARD ASIA/PACIFIC PTE. LTD., Singapore (SG)

(72) Inventors: Himanshu Srivastava, Singapore (SG); Ankoor Desai, Singapore (SG)

(21) Appl. No.: 15/277,573

(22) Filed: Sep. 27, 2016

(30) Foreign Application Priority Data
Sep. 28, 2015 (SG) 10201508062X

(51) Int. Cl. G06Q 40/02; H04L 29/06

(52) U.S. Cl. CPC G06Q 40/02; H04L 63/0838; H04L 63/0861; H04L 63/10; G06Q 50/265

(57) ABSTRACT

A method of performing an action in a branchless banking environment, the method including, in one or more electronic processing devices: (a) receiving at least one identifier associated with an individual from an agent terminal via a communications network; (b) retrieving identity information from a database using the at least one identifier; (c) receiving authentication information supplied by the individual from the agent terminal via the communications network; (d) authenticating the individual using the authentication information and the identity information retrieved from the database; and, (e) performing an action in response to successful authentication, the action including at least one of: (i) establishing an account on behalf of the individual using the identity information; and, (ii) performing a transaction on behalf of the individual.

### FIELD

The present disclosure relates to a method and system for performing an action in a branchless banking environment, for example, establishing a bank account on behalf of an individual or performing a transaction associated with the bank account.

### BACKGROUND

This section provides background information related to the present disclosure which is not necessarily prior art.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Traditional banking infrastructures in many developing and third world countries still requires people to visit a local branch in order to perform a transaction. For many reasons, not least of which includes the high overheads incurred by the banks and the cultural attitudes of many of the citizens, this traditional infrastructure is generally not suited for deployment in these countries.

For example, in the past it has not been uncommon for a person to queue up at the local branch on the day that they get paid and to withdraw the full amount from their account. The money is usually taken home and kept under the bed for security, for example. This is problematic both for the bank as the money is not retained in the account and for the person who does not benefit from account interest or secure savings. A reason for this may be that many people do not feel that their money is secure in the bank account.

Furthermore, the costs incurred by the bank in setting up an account for a new customer are high due to the cost of employee wages, and costs associated with manufacturing bank cards, sending the card out to the customer as well as separately sending the account password or pin. For at least some of these reasons, it is generally prohibitively expensive for financial institutions, such as banks, to set up local branches in many remote and rural areas in developing and third world countries since transaction numbers and volumes do not justify the expense of establishing the branch.

As a result, many people around the world do not have access to or do not use formal financial services.

It is recognised that financial inclusion is a key enabler in reducing poverty and boosting prosperity for those people living in disadvantaged or underserved regions around the world. It has been shown, that providing more people with access to deposit accounts leads to an increase in the gross domestic product (GDP) of the country.

In some countries, a form of banking known as ‘branchless banking’ is available whereby banking agents operating as an intermediary provide an alternative distribution channel for financial institutions. These agents, which are usually retailers such as a local store or postal outlet, are contracted by a financial institution to conduct client transactions such as cash in/cash out services and the like. Banking agents can therefore play a vital role in extending the reach of financial institutions to client segments that may otherwise be excluded from financial services.

The use of agents, such as local retailers, usually presupposes that the individual already has an existing bank account. However, many poor and disadvantaged people do not have bank accounts (“the unbanked”) with which to conduct any transactions at all, at a traditional branch or an agent.

Opening a bank account is quite often a difficult and time consuming process that presents a barrier to many people who wish to have access to financial services. Often various forms of identification are required in order to open an account which the potential customer may not be able to provide. Even if they do have the necessary paperwork, the verification process typically takes a long time, as documents may be sent away for verification, and sometimes get lost in transit. Traditional paper-based know your customer (KYC) methods of verifying the identity of an individual are therefore problematic and may lead to the exclusion of many people from having access to basic financial services.

It is against this background, and the problems and difficulties associated therewith, that the present disclosure has been developed.

### SUMMARY

This section provides a general summary of the disclosure, and is not a comprehensive disclosure of its full scope or all of its features. Aspects and embodiments of the disclosure are also set out in the accompanying claims.

In one broad form, the present disclosure seeks to provide a method of performing an action in a branchless banking environment, the method including, in one or more electronic processing devices:
a) receiving at least one identifier associated with an individual from an agent terminal via a communications network;
b) retrieving identity information from a database using the at least one identifier;
c) receiving authentication information supplied by the individual from the agent terminal via the communications network;
d) authenticating the individual using the authentication information and the identity information retrieved from the database; and,
e) performing an action in response to successful authentication, the action including at least one of:
   i) establishing an account on behalf of the individual using the identity information; and,
   ii) performing a transaction on behalf of the individual.

Typically, the identity information retrieved from the database using the at least one identifier, includes at least one of:
a) a name;
b) an address;
c) a date of birth;
d) a mobile phone number;
e) an electronic communications address; and,
f) biometric information.

Typically, the authentication information includes at least one of:
a) a one-time password (OTP); and,
b) biometric information associated with the individual.

Typically, the method includes:
a) generating the OTP; and,
b) sending the OTP to a client device of the individual.

Typically, the method includes providing the OTP to a client device of the user using the identity information.

Typically, the step of authenticating the individual includes determining whether a received OTP matches a generated OTP.

Typically, the step of authenticating the individual includes determining whether the biometric information received from the agent terminal matches the biometric information retrieved from the database.

Typically, the biometric information received from the agent terminal is based on scan data indicative of a scan of at least one of:
a) a fingerprint;
b) an eye;
c) a hand; and,
d) a face.

Typically, the transaction performed on behalf of the individual includes at least one of:
a) making a cash withdrawal or deposit;
b) sending money to or receiving money from a third party; and,
c) providing a proof of life.

Typically, the identifier received from the agent terminal includes at least one of:
a) a unique identification number; and,
b) a mobile phone number.

Typically, the unique identification number includes a national identification number issued by a government.

Typically, the database used to retrieve the identity information using the at least one identifier is a third party database.

Typically, the third party database is a government database.

Typically, wherein the method is for use in establishing an account on behalf of the individual, the method further includes sending an account activation message to a client device of the individual.

Typically, wherein the method is for use in establishing an account on behalf of the individual, the method further includes storing account information in a partitioned database, each partition of the database storing account information related to customers of a different financial institution.

Typically, the identity information is used to verify an identity of the individual.

In another broad form the present disclosure seeks to provide a method of establishing a bank account on behalf of an individual in a branchless banking environment, the method including, in one or more electronic processing devices:
a) receiving an identifier associated with an individual from an agent terminal via a communications network;
b) retrieving identity information from a database using the identifier;
c) receiving authentication information supplied by the individual from the agent terminal;
d) authenticating the individual using the authentication information and the identity information retrieved from the database; and,
e) in response to successful authentication, establishing an account on behalf of the individual using the identity information.

Typically, the method further includes sending an account activation message to a client device of the individual.

Typically, the method further includes storing account information in a partitioned database, each partition of the database storing account information related to customers of a different financial institution.

In a further broad form the present disclosure seeks to provide a system for performing an action in a branchless banking environment, the system including one or more electronic processing devices that:
a) receive an identifier associated with an individual from an agent terminal via a communications network;
b) receive authentication information supplied by the individual from the agent terminal;
c) retrieve identity information from a database using the identifier;
d) authenticate the individual using the authentication information and the identity information retrieved from the database; and,
e) perform an action in response to successful authentication, the action including at least one of:
   i) establishing an account on behalf of the individual using the identity information; and
   ii) performing a transaction on behalf of the individual.

Typically, the electronic processing device is configured to serve multiple tenants.

Typically, the tenants are financial institutions.

Typically, the system further includes a partitioned database for storing customer account information, each partition of the database storing customer account information associated with a particular financial institution and wherein the electronic processing device is in communication with the partitioned database.

Typically, the electronic processing device includes a computer-readable storage medium coupled to a processor, the computer-readable storage medium comprising code executable by the processor in the form of applications software.

Typically, the agent terminal includes a computer-readable storage medium coupled to a processor, the computer-readable storage medium comprising code executable by the processor in the form of applications software.

Typically, the authentication information includes at least one of:
a) a one-time password (OTP); and,
b) biometric information associated with the individual.

Typically, the biometric information is scanned by a biometric reader device in communication with the agent terminal.

Typically, the identifier received from the agent terminal includes at least one of:
a) a unique identification number; and,
b) a mobile phone number.

Typically, the identity information retrieved from the database using the at least one identifier includes at least one of:
a) a name;
b) an address;
c) a date of birth;
d) a mobile phone number;
e) an electronic communications address; and,
f) biometric information.

Typically, the database used to retrieve the identity information using the at least one identifier is a third party database.

Typically, the third party database is a government database.

It will be appreciated that the broad forms of the disclosure and their respective features can be used in conjunction, interchangeably and/or independently, and reference to separate broad forms in not intended to be limiting.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, a non-limiting example of the present disclosure will now be described with reference to the accompanying drawings, in which:

FIG. 1 is a flow chart of an example of a method of performing an action in a branchless banking environment;

FIG. 2 is a schematic diagram of an example of a system for performing an action in a branchless banking environment;

FIG. 3 is a schematic diagram of an example of a branchless banking system of FIG. 2;

FIG. 4 is a schematic diagram of an example of a client device of FIG. 2;

FIG. 5 is a schematic diagram of an example of an agent terminal of FIG. 2;

FIGS. 6A and 6B are a flow chart of an example of a method of establishing a bank account for an individual;

FIGS. 7A to 7F are examples of graphical user interfaces generated by the system of FIG. 2 in the process of establishing a bank account on behalf of an individual;

FIG. 8 is an example of a graphical user interface of an application provided on a client device; and

FIGS. 9A to 91 are examples of graphical user interfaces generated by the system of FIG. 2 in the process of withdrawing cash from a user's account.

Corresponding reference numerals generally indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

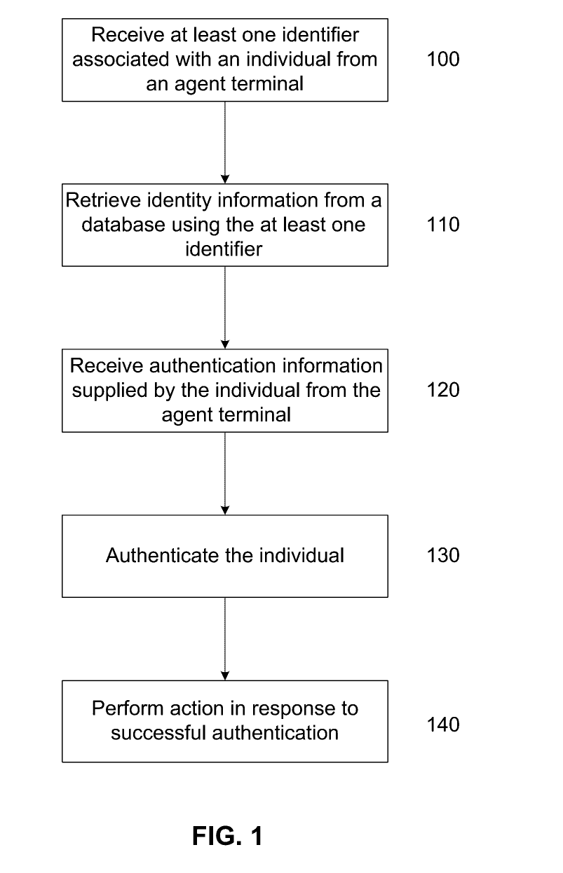

An example of a method of performing an action in a branchless banking environment will now be described with reference to FIG. 1.

For the purpose of illustration, it is assumed that the method is performed at least in part using one or more electronic processing devices forming part of one or more processing systems, such as computer systems, servers or the like, which are in turn connected to one or more client devices and/or agent terminals, such as mobile phones, portable computers, tablet computers, point of sale (POS) systems, or the like, via a network architecture, as will be described in more detail below.

The term agent is intended to cover any entity, including a company, organisation, individual or the like that is acting as a banking agent on behalf of a financial institution or the like. Agents may take numerous forms including, for example, local stores, pharmacies, supermarkets and convenience stores and acts as an intermediary between the individual and a financial institution, such as a bank, and facilitates financial and non-financial transactions for the individual. It will be appreciated that the term is therefore used for the purpose of illustration only and is not intended to be limiting.

In this example, at step 100 the processing device receives at least one identifier associated with an individual from an agent terminal via a communications network.

The identifier may be of any appropriate form but will typically include one or more of a unique identification number such as a national identification number and/or a mobile phone number. Many countries around the world have electronic identification programs where residents are provided with unique identification numbers which are often associated with other unique forms of identity such as biometric information, for example, fingerprint scans. The information is often recorded in a government database and citizens may be issued with an electronic ID card or the like. In India, for example, residents are issued with an Aadhaar number which is a 12 digit individual identification number issued by the Unique Identification Authority of India on behalf of the Government of India. An Aadhaar number serves as a proof of identity and address, anywhere in India. Biometric and other identity information is also collected and associated with each Aadhaar number.

Other such identity information that may be associated with a unique identification number and stored in a government database includes, for example, a name, an address, a date of birth and a mobile phone number.

The identifier can be provided in any suitable manner. For example, an individual will typically present at a banking agent, such as a retailer or postal outlet, to perform a financial or non-financial transaction. The individual provides their at least one identifier to the agent who enters the information into an agent terminal, such as personal computer (PC) or mobile device, such as tablet. Typically, the agent terminal is running applications software such as a web based application or application executing on a tablet. The agent terminal sends the at least one identifier associated with the individual to the processing system via the communications network as will be described in more detail later.

At step 110, the processing device retrieves identity information from a database using the at least one identifier. Having received the at least one identifier associated with the individual, such as their unique identification number and/or mobile phone number, the processing device queries the database which contains corresponding identity information for the individual. Typically, the database is a third party database such as a government database which contains identity information of national residents of a particular country, although this is not essential. In another example, the database may be owned by the entity which operates the one or more processing systems (e.g. branchless banking server(s)).

At step 120, the processing device receives authentication information supplied by the individual from the agent terminal via the communications network. The manner in which the authentication information is provided will depend on the nature of the authentication information. For example, the authentication information can include either a one-time password (OTP) or biometric information associated with the individual, in which case the OTP can be input via a user interface into the terminal, or the biometric information can be scanned using a suitable scanning device, such as a finger print reader, or the like.

In some examples, both an OTP password and biometric information may be used to authenticate the individual while in other examples one or the other may be used. It will be appreciated that using biometric information is preferred due to the increased security but that in some instances this may not be possible, for example, if the database is unavailable or if biometric information associated with the individual is not stored in the database.

Typically, an OTP password is sent to a client device of the individual such as a mobile phone. This is reasonably secure when a unique identification number is provided as the processing system will retrieve the mobile phone number stored in the database that is registered to the individual associated with the unique identification number provided and send the OTP to that number.

If an OTP password is used, the individual receives the OTP on their client device and provides this to the agent who enters it into the agent terminal. If biometric information is used to authenticate the individual, the biometric information of the individual is scanned and recorded by the agent terminal. The agent terminal then sends the authentication information (OTP or scanned biometric information) to the processing device for processing.

It will be appreciated that the order of steps 110 and 120 is for the purpose of illustration only and is not intended to be restrictive. For example, in the case of using biometric data, the individual could provide this simultaneously with the identifier, allowing these to be provided to the processing device(s) in advance of the identity information being retrieved.

At step 130, the processing device authenticates the individual using the authentication information and the identity information retrieved from the database. For example, if an OTP is used the processing device determines whether the received OTP from the agent terminal matches the OTP that was sent to the client device. If biometric information is used, the processing device determines whether the biometric information received from the agent terminal matches the biometric information retrieved from the database.

At step 140, an action is performed in response to successful authentication. If authentication is not successful then the process will be aborted and will need to be repeated.

Typically, the action to be performed includes establishing (or issuing) an account on behalf of the individual using the identity information or performing a transaction on behalf of the individual. In the case of establishing an account for the individual, the account is issued to the individual using the identity information that was retrieved from the database, such as the individual's name and address. In this way, the identity of the individual is verified and the financial services account is approved instantly.

If an account is already established, then the action may include performing a transaction on behalf of the individual including, for example, making a cash withdrawal or deposit, sending money to or receiving money from a third party, such as another account holder, an employer or the government, and providing a proof of life.

Accordingly, it will be appreciated that at least in one example, the above described process leverages the existence of identity information associated with a database (e.g. a trusted third party database), such as owned by a government agency, or the like, in order to verify the identity of an individual presenting themselves to an agent. Alternatively, the database may be owned or maintained by the scheme operator. This avoids the need for the user to provide proof of identity documentation, and allows the agent and scheme operator to establish the identity of the individual using a straightforward mechanism.

This in turn allows the above described method to provide a number of advantages. For example, it enables a know your customer (KYC) compliance check to be performed easily and quickly, enabling a financial services account to be established and issued to an individual on the spot and without delay. It enables an individual to establish an account at an agent, such as a local retailer, with which they will be familiar and trust. As an account can be issued without requiring any paperwork, and without requiring any forms to be sent away, it is far more likely that more people in underserved regions of the world will be provided access to at least basic financial services, such as having a deposit account.

By providing greater access to bank accounts, people are able to perform various transactions, such as topping up the account by cash at an agent, receiving funds from other account holders, receiving payments from an employer or the government, including benefits, subsidies and the like, transferring funds to other account holders, and withdrawing cash at an agent. By providing secure authentication, individuals will begin to feel confident using their accounts and will begin to trust that their funds and transactions are safe and secure.

The ability for agents to issue financial accounts on the spot to individuals also enables financial institutions to economically reach new market segments that previously would have been out of reach. The above described method enables individuals to open accounts and perform transactions easily and securely without traditional banking infrastructures, such as local branches, employees and IT infrastructures. For example, accounts are able to be issued electronically, without the traditional overheads of employees, manufacturing bank cards and sending cards to the customer along with separate correspondence containing PINs and passwords, etc. Financial institutions are therefore able to significantly reduce overheads whilst still being able to provide financial services to customers most in need through a network of agents.

In this way, the method promotes financial inclusion in developing and third world countries, in particular remote and rural regions thereof.

A number of further features will now be described.

In one example, the identity information retrieved from the database using the at least one identifier includes at least one of a name, an address, a date of birth, a mobile phone number, an electronic communications address, such as an email address, skype name or the like, and biometric information. The identity information may further include marital status, religion, gender, occupation, nationality, photos, signature or other demographic information. Typically, several items of this identity information are used to verify the identity of the individual. Since this information is often readily available in government databases and the like, the process of authentication can be performed electronically without the overheads associated with traditional paper based verification systems.

In one example, the authentication information includes at least one of a one-time password (OTP) and biometric information associated with the individual. As previously described, an OTP and biometric information may be used in conjunction for increased security. However, generally it is acceptable to use one or the other for purposes of authenticating the individual. As biometric information, such as fingerprint scans, is unique to each individual based on measurable physical characteristics, this authentication method provides enhanced security as unlike passwords and pin numbers, for example, a person's biometric information cannot be stolen or duplicated. The use of an OTP may be considered reasonably secure where an individual also provides a unique identification number which is associated with a registered mobile phone number. The OTP is then sent to that registered mobile phone number and therefore even if the phone was stolen, for example, the individual would also need to know the unique identification number associated with that particular mobile phone number to enable them to be authenticated.

Whilst the use of biometric information is preferred, there may be situations where an OTP is more applicable, such as when the database is unavailable or if biometric information associated with the individual is not stored in the database.

If an OTP is used to authenticate the individual, the method further includes generating the OTP and sending the OTP to a client device of the individual. The processing device generates the OTP using any suitable generation algorithm as is well known in the art. The OTP is sent to the client device of the individual which is typically a mobile phone via a communications network, typically a cellular network including, for example, GSM, GPRS or any other suitable technology. The OTP is generally received on the client device by a text message although this is not essential and the OTP could be delivered in any suitable way, for example, by an automated call using text to speech conversion.

In one example, such as when an OTP is used, the step of authenticating the individual includes determining whether the received OTP matches the generated OTP. Typically, upon receiving the OTP on their client device, the individual is further prompted to provide the OTP to the agent for KYC validation. The agent enters the OTP provided by the individual into the agent terminal. The OTP entered by the agent is then sent to the processing device which determines whether the received OTP from the agent terminal matches the OTP that was generated. If there is a match, an action is able to be performed, such as establishing an account on behalf of the individual or performing a transaction.

In another example, where biometric information is used, the step of authenticating the individual includes determining whether the biometric information received from the agent terminal matches the biometric information retrieved from the database. The biometric analysis performed by the processing device may include any suitable technique that is known in the art in order to assess the similarity between a biometric scan and previous biometric information of an individual that is stored in a database. For example, particular features of the scan are often extracted, such as key points which enable measurements to be made which can then be compared to corresponding points and measurements from the stored information enabling a comparison score to be determined. Recognition can be confirmed if the comparison score exceeds a threshold, for example. The use of biometric authentication is particularly useful as in many countries there already exists a database containing biometric information for many residents that can be utilised.

The biometric information received from the agent terminal is based on scan data indicative of a scan of at least one of a fingerprint, an eye, a hand or a face, although any other suitable biometric information may be used. Typically, a finger print scan will be used, however depending on the hardware available to the agent and the particular type of biometric information stored in the database, many other forms of biometric information could foreseeably be used. For example, an eye scan could be performed to capture iris and retina information, a voice recording could be made or the dynamic characteristics of a signature could be captured.

Typically, the biometric information is scanned by a biometric reader device in communication with the agent terminal. The biometric reader device may be integrated as part of the agent terminal or it may be a standalone device connected to the agent terminal. The agent terminal will typically be running an applications software configured to capture the scanned biometric data and send it to the processing device for comparative analysis with the biometric information stored in the database.

In one example, the identifier received from the agent terminal includes at least one of a unique identification number and a mobile phone number. As previously mentioned, the unique identification number may be a national ID number which is issued to residents of several countries and is often associated with biometric information of the individual. In India, for example, residents typically have a unique national ID number known as an Aadhaar Number. In Indonesia, residents have an eKTP number which may be used as a unique identification number in the present system. The use of a unique identification number is advantageous as this number is unique to each individual as opposed to simply a name, for example, which may not be unique.

It is also advantageous that the unique identification number and associated biometric information (and other identity information) is stored in a database (such as a third party database) which can be accessed by the processing device for purposes of identity verification. Typically, the above described data is stored in a government database, although this is not essential and indeed it is foreseeable that non-government entities may maintain databases containing identity information of residents of a country. The database may also form part of a cloud based computing environment, although this is not essential.

In one example, for use in establishing an account on behalf of the individual, the method further includes sending an account activation message to the client device of the individual. The message may be a text message received on the client device informing the individual that an account has been issued and inviting them to activate the account by downloading an application onto their device. The client application may be downloaded, for example, from an application store such as Apple's App Store™ or the Google Play™ Store, depending on the type of device used by the individual. Having downloaded the client application, the client may then proceed to activate their account and begin performing transactions.

Once an account has been issued, in one example, the method further includes storing account information in a partitioned database, each partition of the database storing account information related to customers of a different financial institution. The system is designed to serve multiple tenants (for example, financial institutions, such as banks) and accordingly it is important that each financial institution is provided access to their respective customer account information. After an account has been issued, the processing device ensures that the new account information is stored in the correct partition of the database related to the associated financial institution. Each financial institution participating in the system will have access to their relevant partition of the database. The account information stored in the partitioned database may include the account number, customer details, such as name, address and mobile phone number and associated biometric information that was retrieved from the database using the identifier during account issuance.

After an account has been created, an individual is able to partake in various transaction based activities, which may be financial or non-financial in nature. In one example, the transaction performed on behalf of the individual includes at least one of making a cash withdrawal or deposit, sending money to or receiving money from a third party and providing a proof of life. For example, an individual is able to transfer or receive money from a friend perhaps in order to pay back or give a loan. The individual is able to receive income from an employer or benefits or subsidies from the government. The individual is also able to deposit cash into their account or to withdraw cash from their account whatever the need may be. The account may further enable the individual to accrue interest on their savings and may provide them with a sense of security that their money is safe in the account.

The previously described authentication processes may be used in performing one or more of the above transactions which leads to increased security and confidence in electronic banking for individuals who may not have previously trusted or had access to such forms of banking. Whilst biometric information used for purposes of authentication may be retrieved from a third party database, after account issuance it may be possible to instead retrieve biometric information that is stored in the partitioned database and associated with the individual's account. The system is also advantageous for governments who have traditionally had difficulty in ensuring that benefits and the like actually reach the intended recipients. The system therefore may facilitate government payments directly into the accounts of the intended individual recipients without the leakage that often occurs at present.

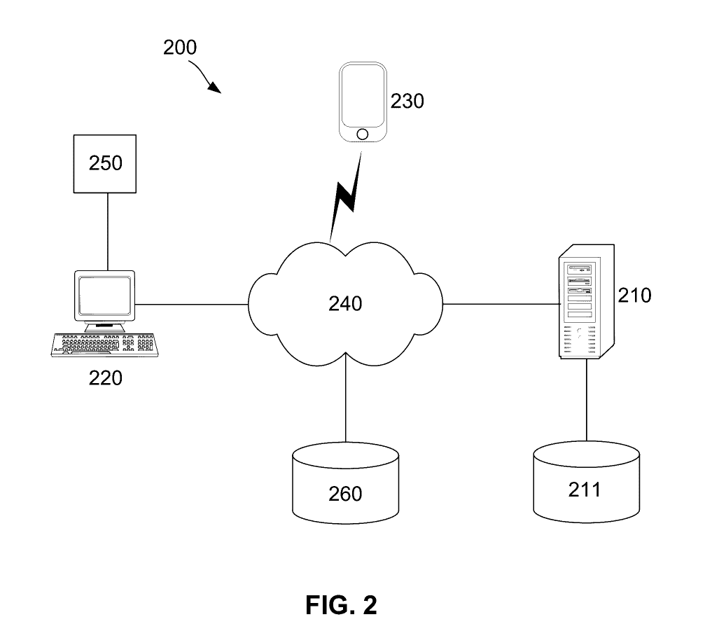

An example of a system for performing an action in a branchless banking environment will now be described with reference to FIG. 2.

In this example, the system 200 includes at least one electronic processing device, such as a server 210 in communication with one or more agent terminals 220 and client devices 230 via one or more communications networks 240. The server 210 is also in communication with a database 260 containing identity information of individuals via the communications network 240 and a partitioned database 211 for storing customer account information. In practice, the system 200 will include multiple agent terminals 220 and client devices 230 in communication with the server 210.

In this example, the agent terminals 220 are provided in numerous geographic locations around a country or region and represent computing devices operated by banking agents able to perform actions on behalf of a financial institution. Likewise, the client devices 230 and associated users will usually be located in numerous geographic locations.

The communications network 240 can be of any appropriate form, such as the Internet and/or a number of local area networks (LANs) and provides onward connectivity to one or more agent terminals 220, client devices 230, and the server 210, which is in turn coupled to the partitioned database 211. It will be appreciated that this configuration is for the purpose of example only, and in practice the agent terminals 220, client devices 230 and server 210 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like.

In one example, the server 210 is adapted to authenticate the individual using either or both of OTP or biometric authentication processes, as well as generating representations and/or alerts as required, with these being provided to the agent terminals 220 and client devices 230 as required. Whilst the server 210 is shown as a single entity, it will be appreciated that the server 210 can be distributed over a number of geographically separate locations, for example, by using processing systems and/or databases 211 that are provided as part of a cloud based environment. However, the above described arrangement is not essential and other suitable configurations could be used.

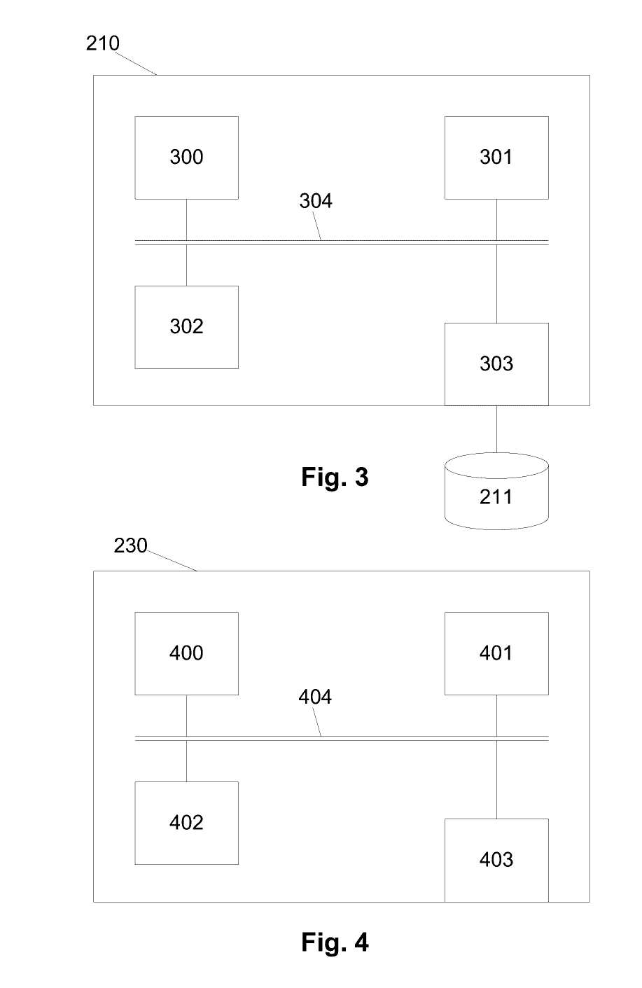

An example of a suitable server 210 is shown in FIG. 3. In this example, the server 210 includes at least one microprocessor 300, a memory 301, an optional input/output device 302, such as a keyboard and/or display, and an external interface 303, interconnected via a bus 304, as shown. In this example the external interface 303 can be utilised for connecting the server 210 to peripheral devices, such as the communications networks 240, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed, including communicating with the agent terminals 220 and client devices 230, generating webpages, for example, including representations of the authentication process, actions to be performed and/or other information. The applications software may include one or more software modules, and may be executed in a suitable execution environment, such as an operating system environment, or the like. In one example, the server 210 is configured to execute an instance of a branchless banking application serving multiple tenants (such as financial institutions).

Accordingly, it will be appreciated that the server 210 may be formed from any suitable processing system, such as a suitably programmed computer system, PC, web server, network server, or the like. In one particular example, the server 210 is a standard processing system, such as an Intel Architecture based processing system, which executes software applications stored on non-volatile (e.g., hard disk) storage, although this is not essential. However, it will also be understood that the processing system could be any electronic processing device, such as a microprocessor, microchip processor, logic gate configuration, firmware optionally associated with implementing logic such as an FPGA (Field Programmable Gate Array), or any other electronic device, system or arrangement.

As shown in FIG. 4, in one example, the client device 230 includes at least one microprocessor 400, a memory 401, an input/output device 402, such as a keyboard and/or display, and an external interface 403, interconnected via a bus 404, as shown. In this example, the external interface 403 can be utilised for connecting the client device 230 to peripheral devices, such as the communications networks 240, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the server 210, for example, to allow the individual to activate an account and perform various transactions, such as cash out, send money and check balance of account.

Accordingly, it will be appreciated that the client devices 230 may be formed from any suitable processing system, such as a suitably programmed PC, Internet terminal, lap-top, or hand-held PC, and in one preferred example is either a tablet, or smart phone, or the like. Typically, the client device 230 is a mobile phone having connectivity and an associated mobile number stored in the database that is associated with a unique identification number of the individual. Thus, in one example, the client device 230 is a standard processing system, such as an Intel Architecture based processing system, which executes software applications stored on non-volatile (e.g., hard disk) storage, although this is not essential. However, it will also be understood that the client devices 230 can be any electronic processing device, such as a microprocessor, microchip processor, logic gate configuration, firmware optionally associated with implementing logic such as an FPGA (Field Programmable Gate Array), or any other electronic device, system or arrangement.

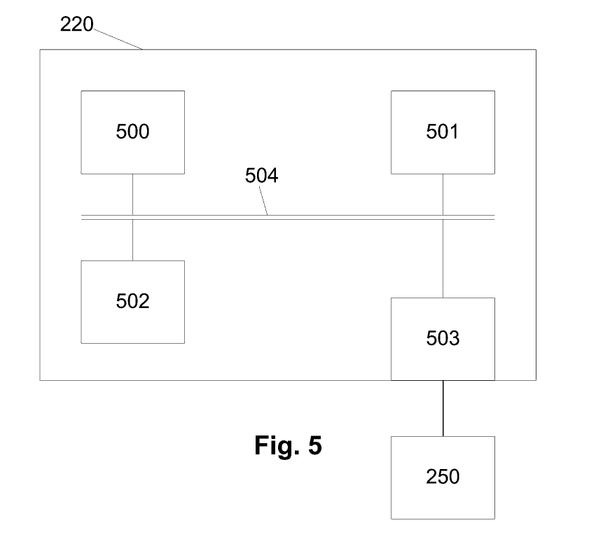

As shown in FIG. 5, in one example, the agent terminal 220 includes at least one microprocessor 500, a memory 501, an input/output device 502, such as a keyboard and/or display, and an external interface 503, interconnected via a bus 504, as shown. In this example the external interface 503 can be utilised for connecting the agent terminal 220 to peripheral devices, such as the communications networks 240, biometric reader devices 250 databases, other storage devices, or the like. Although a single external interface 503 is shown, this is for the purpose of example only, and in practice multiple interfaces using various methods (e.g. Ethernet, serial, USB, wireless or the like) may be provided.

In use, the microprocessor 500 executes instructions in the form of applications software stored in the memory 501 to allow communication with the server 210, for example, to establish an account on behalf of the individual or assist the individual in performing a transaction.

Accordingly, it will be appreciated that the agent terminals 220 may be formed from any suitable processing system, such as a suitably programmed PC, Internet terminal, lap-top, or hand-held PC, and in one preferred example is either a tablet, or smart phone, or the like. Thus, in one example, the agent terminal 220 is a standard processing system such as an Intel Architecture based processing system, which executes software applications stored on non-volatile (e.g., hard disk) storage, although this is not essential. However, it will also be understood that the agent terminals 220 can be any electronic processing device such as a microprocessor, microchip processor, logic gate configuration, firmware optionally associated with implementing logic, such as an FPGA (Field Programmable Gate Array), or any other electronic device, system or arrangement.

Examples of the operation of the system for performing an action in a branchless banking environment, will now be described in further detail. For the purpose of these examples it will also be assumed that users interact with the system via a GUI (Graphical User Interface), or the like, presented on the agent terminal 220 and client device 230, which may be generated by a local application, or hosted by the server 210 and displayed via a suitable application, such as a web browser or the like, executed by the agent terminal 220 or client device 230. Actions performed by the client device 230 are typically performed by the processor 400 in accordance with instructions stored as applications software in the memory 401 and/or input commands received from a user via the I/O device 402. Actions performed by the agent terminal 220 are performed by the processor 500 in accordance with instructions stored as applications software in the memory 501 and/or input commands received from a user via the I/O device 502, or commands received from the server 210. Similarly, actions performed by the server 210 are performed by the processor 300 in accordance with instructions stored as applications software in the memory 301 and/or input commands received from a user via the I/O device 302, or commands received from the client device 230 or agent terminal 220.

However, it will be appreciated that the above described configuration assumed for the purpose of the following examples is not essential, and numerous other configurations may be used. It will also be appreciated that the partitioning of functionality between the agent terminals 220, client devices 230, and server 210 may vary, depending on the particular implementation.

For example, in the current configuration, the server 210 is assumed to be the primary processing device, for example, in analysing authentication information and performing actions, such as issuing accounts and performing transactions. It will be appreciated from this that the use of the server as the primary processing device, whilst convenient, is not essential, and similar functionality could be achieved by having some functionality performed by the server 210 implemented locally by the agent terminal, for example. In another example, the agent terminal may be in direct communication with the database 260 containing the identity information and may be configured to authenticate the identity of the individual.

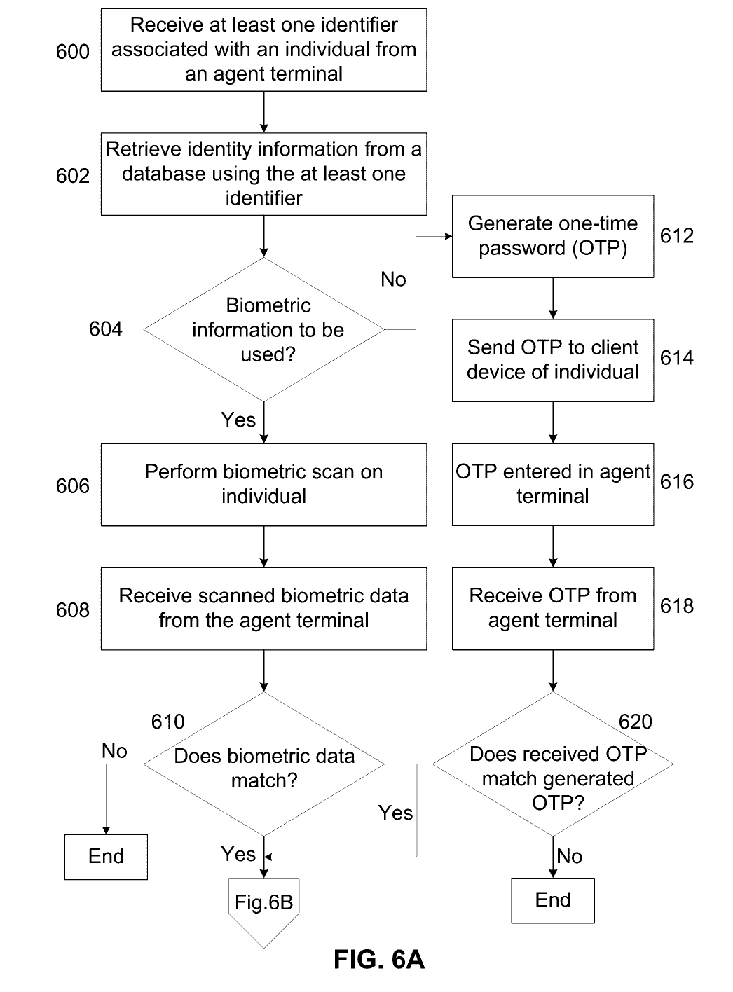

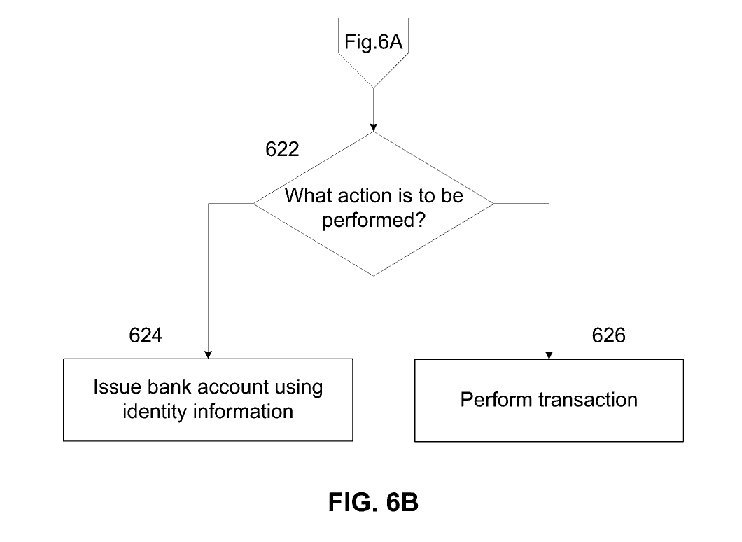

An example of operation of the system described above will be now be described with reference to FIGS. 6A and 6B, which show the process of performing an action in a branchless banking environment.

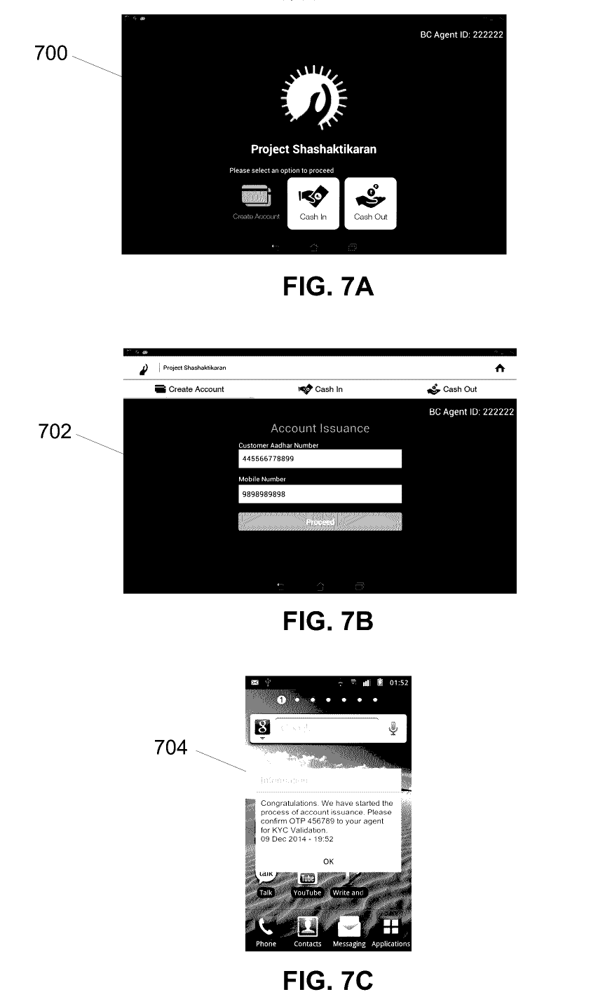

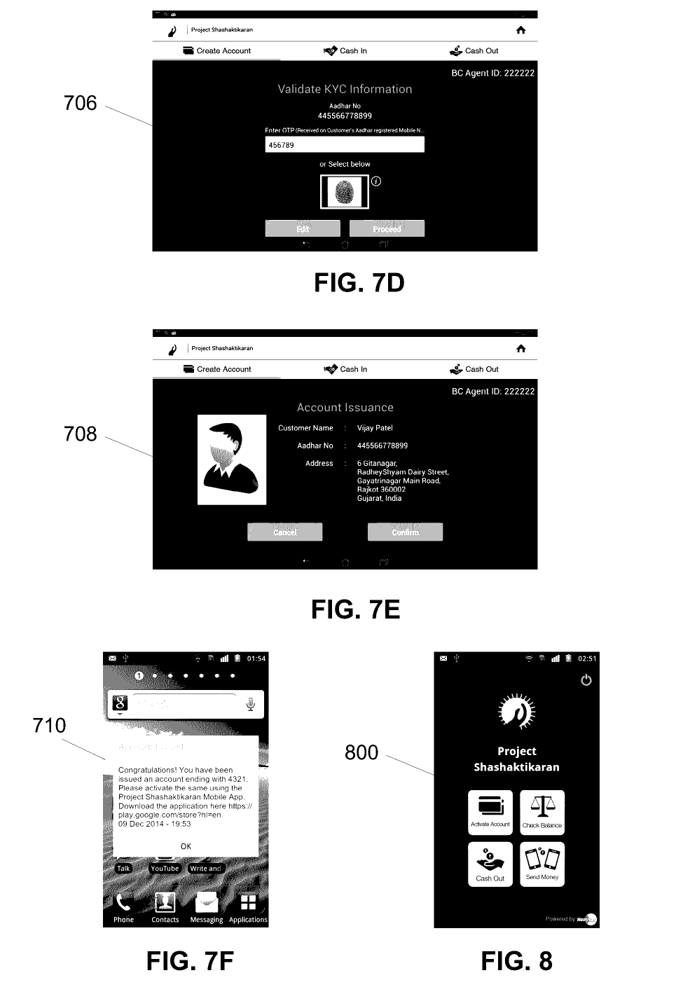

In this example, at step 600 at least one identifier associated with an individual is received by the server 210 from the agent terminal. As previously described, the identifier may be of any appropriate form but will typically include one or more of a unique identification number, such as a national identification number and/or a mobile phone number. The individual provides the at least one identifier to the agent who enters the information into an agent terminal 220 via the input/output device associated with the agent terminal 220. The at least one identifier is input by the agent into a form generated by the applications software executing on the agent terminal 220. An example of a user interface 702 presented on the agent terminal for entering identifier information is shown in FIG. 7B. When the agent submits this form, the at least one identifier is sent via the communications network to the server 210.

In response to receiving the identifier information, at step 602, the server 210 retrieves identity information from the database 260 (such as a third party government database) using the at least one identifier. At this point, at step 604 the server 210 may determine whether or not biometric information is to be used for purposes of authentication. For example, if the database 260 is unavailable, or if there is no biometric information stored in the database associated with the identifier, or if the agent terminal 220 or client device 230 does not include a biometric scanner, then the server will generate an OTP for purposes of authentication at step 612. At step 614, the generated OTP is then sent to a client device 230 of the user using the identity information retrieved from the database at step 602. For example, it will be appreciated that it is more secure if the OTP is sent to a mobile phone number that is stored in the database 260 that has previously been established as belonging to the individual by association with the unique identification number, for example. In one example, the OTP is sent by text message to the client device 230 as represented by the user interface 704 of the client device shown in FIG. 7C.

Upon receiving the OTP, the individual then provides the OTP to the agent who enters the OTP into the agent terminal via the input/output device. An example of a user interface 700 presented on the agent terminal for entering the OTP is provided in FIG. 7A. The agent then submits the form with the OTP provided by the individual and this is sent to the server 210 where the information is received from the agent terminal 220 at step 618.

At step 620, the server 210 then determines whether the OTP received from the agent terminal 220 matches the OTP generated by the server 210 and sent to the client device 230. If there is a match, the individual is authenticated.

If at step 604 the server 210 had determined that biometric information was to be used in the authentication process, for example, when the database 260 is available and there is stored biometric information associated with the individual that is retrieved from the database, then a biometric scan of the individual is performed.

Accordingly, at step 606, a biometric scan is performed using a biometric reader device 250 in communication with the agent terminal 220. Typically, a finger scan is completed and biometric information captured by the agent terminal 220. At step 608, biometric information or data is received from the agent terminal 220. The data received by the server 210 is based on scan data indicative of a scan and may include, for example, data that has been processed, extracted or compressed from the scan.

At step 610, the server 210 determines whether the biometric information received from the agent terminal 220 matches the biometric information retrieved from the database 260. As previously described, any suitable technique may be used in comparing the biometric data to determine the degree of correlation and statistical probability of a match. If the result of either of steps 610 or 620 is an unsuccessful authentication, then the process aborts and will have to be started over.

If authentication by either (or both) the OTP or biometric information is successful, as shown in FIG. 7D, user interface 706, then the system determines what action is to be performed (at step 622, FIG. 6B) based on previous input by the agent, for example, using the user interface 700 shown in FIG. 7A. If the required action was to create an account, then the server 210 at step 624 issues a new account to the individual using the identity information previously retrieved at step 602. Thus, this information is used to verify the identity of the individual (e.g. name, address etc.) when first establishing an account.

The agent terminal 220 receives a form as shown by the user interface 708 in FIG. 7E and is prompted to confirm customer details for account issuance. Once confirmed, the account is created, with account details being stored in a suitable partition in the database 211. The individual also typically receives a text message notifying them of such and prompting them to activate the account by downloading a client application onto the device. This is depicted by the example of a user interface 710, FIG. 7E, provided on the client device of the individual after account issuance.

An example user interface 800 of a client application executing on a client device 230 is shown in FIG. 8.

Several basic options may be presented to the individual including activate account, check balance, cash out and send money, etc. It will be appreciated that many different functionalities may be enabled for the individual to use depending on the level of sophistication of their account.

If the required action was instead to perform a transaction (such as cash out) then at step 626, the transaction is performed. Whilst identity information, such as name and address retrieved from the database 260 may be used to verify the identity of the individual, usually it will be sufficient to merely authenticate that the individual is the same person who previously opened or used the account.

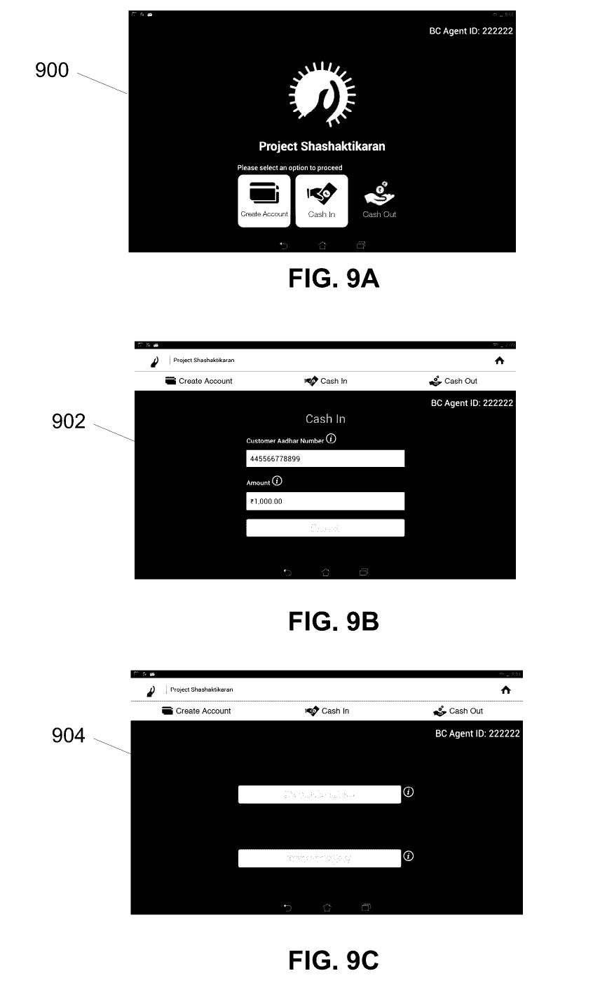

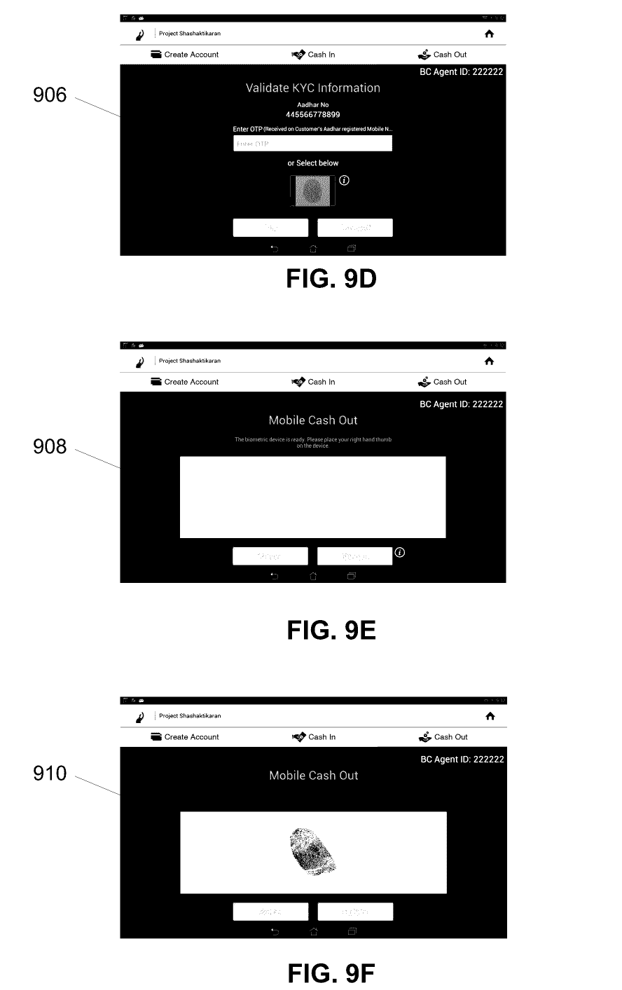

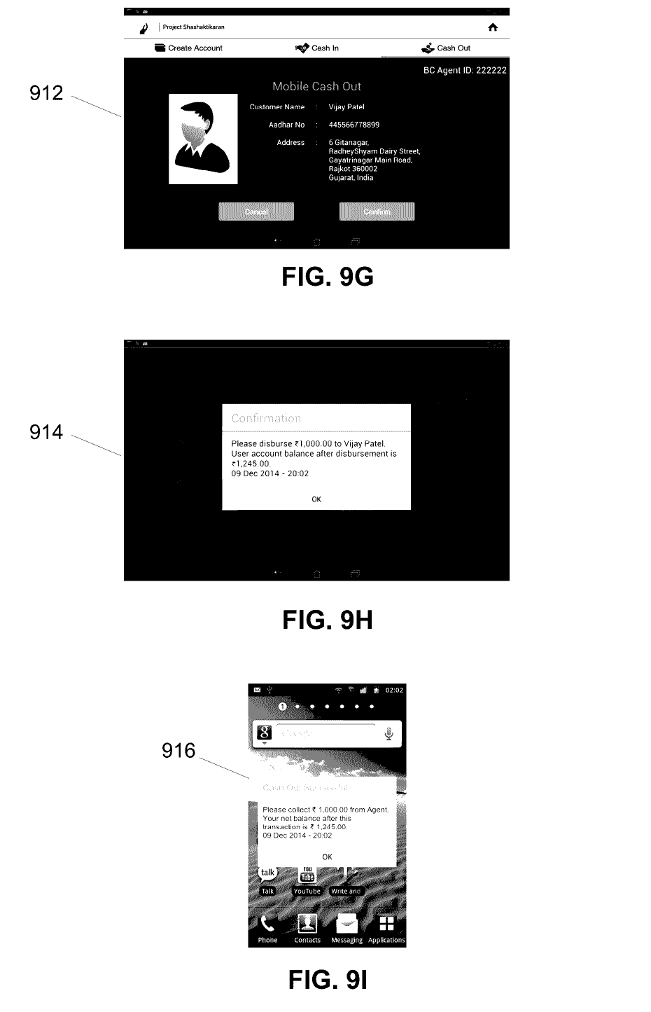

Examples of graphical user interfaces displayed on the agent terminal 220 and client device 230 generated by the system in the process of withdrawing cash from a user's account are shown in FIGS. 9A to 91.

In FIG. 9A, user interface 900, the agent selects cash out as the action to be performed using the agent terminal 220. In the form shown in FIG. 9B, user interface 902, the agent inputs the individuals identifier (such as unique identification number) and hits the proceed button. In FIG. 9C, user interface 904a form is displayed to the agent asking them to confirm whether the transaction is retailer or customer initiated. The agent then either enters an OTP supplied by the individual or selects a biometric scan option as shown in the user interface 906 shown in FIG. 9D.

If a biometric scan is selected, the individual places their finger or thumb on the biometric device reader and the agent initiates the image capture using the user interface 908 shown in FIG. 9E. An image of the individual's thumb or finger is captured which is transferred to the agent terminal 220 and shown on the user interface 910 for review by the agent as shown in FIG. 9F. If the scan is acceptable, the biometric information is sent to the server 210 for analysis, in particular allowing comparison of this to biometric information retrieved from the database 260 containing the identity information.

If authentication is successful, the agent is prompted to confirm the identity of the individual with their name and address information provided by the user using the user interface 912 shown in FIG. 9G. In other examples, this step may not be necessary. A confirmation message 914 shown in FIG. 9H is then displayed to the agent instructing them to disburse the cash to the individual and the individual receives a notification 916 shown in FIG. 9I on their client device that the transaction was successful.

It will be appreciated that once an account is established for an individual using the methods described herein, the account may be used for numerous beneficial purposes including receiving benefits and subsidies from the government, transferring money between other account holders in a mobile to mobile transaction, making deposits and checking balances. In the case of receiving government or NGO benefits and subsidies, a government/NGO agent may send funds directly to recipient's accounts using a government/NGO agent terminal executing applications software which may be configured, for example, to upload funds disbursement files to intended recipients.

Accordingly, it will be appreciated that in at least one example the above described system may leverage identity information stored in a database (such as a trusted third party database), together with authentication processes, involving the use of OTPs or biometric information, allowing an identity of individuals to be verified and hence allowing branchless banking and other processes to be performed. This makes access to such functions feasible for many individuals, without requiring physical attendance at banking or other similar institutions, and without requiring standard paper or other similar verification processes.

With that said, it should be appreciated that one or more aspects of the present disclosure transform a general-purpose computing device into a special-purpose computing device when configured to perform the functions, methods, and/or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Persons skilled in the art will appreciate that numerous variations and modifications will become apparent. All such variations and modifications which become apparent to persons skilled in the art, should be considered to fall within the spirit and scope that the disclosure broadly appearing before described.

What is claimed is:

1. A method of performing an action in a branchless banking environment, the method including, in one or more electronic processing devices:
receiving at least one identifier associated with an individual from an agent terminal via a communications network;
retrieving identity information from a database using the at least one identifier;
receiving authentication information supplied by the individual from the agent terminal via the communications network;
authenticating the individual using the authentication information and the identity information retrieved from the database; and
performing an action in response to successful authentication, the action including at least one of:
establishing an account on behalf of the individual using the identity information; and
performing a transaction on behalf of the individual.

2. The method according to claim 1, wherein the identity information retrieved from the database, using the at least one identifier, includes at least one of:
a name;
an address;
a date of birth;
a mobile phone number;
an electronic communications address; and
biometric information.

3. The method according to claim 1, wherein the authentication information includes at least one of:
a one-time password (OTP); and
biometric information associated with the individual.

4. The method according to claim 3, wherein the method includes:
generating the OTP; and
sending the OTP to a client device of the individual.

5. The method according to claim 4, wherein the method includes providing the OTP to a client device of the user using the identity information; and
wherein the step of authenticating the individual includes determining whether a received OTP matches a generated OTP.

6. (canceled)

7. The method according to claim 3, wherein the step of authenticating the individual includes determining whether the biometric information received from the agent terminal matches the biometric information retrieved from the database.

8. (canceled)

9. The method according to claim 1, wherein the transaction performed on behalf of the individual includes at least one of:
making a cash withdrawal or deposit;
sending money to or receiving money from a third party; and
providing a proof of life.

10. The method according to claim 1, wherein the identifier received from the agent terminal includes at least one of:
a unique identification number; and
a mobile phone number.

11. The method according to claim 10, wherein the unique identification number includes a national identification number issued by a government.

12.-14. (canceled)

15. The method according to claim 1, wherein the method is for use in establishing an account on behalf of the individual, and wherein the method further includes storing account information in a partitioned database, each partition of the database storing account information related to customers of a different financial institution.

16. The method according to claim 1, wherein the identity information is used to verify an identity of the individual.

17. A method of establishing a bank account on behalf of an individual in a branchless banking environment, the method including, in one or more electronic processing devices:
receiving an identifier associated with an individual from an agent terminal via a communications network;
retrieving identity information from a database using the identifier;
receiving authentication information supplied by the individual from the agent terminal;
authenticating the individual using the authentication information and the identity information retrieved from the database; and
in response to successful authentication, establishing an account on behalf of the individual using the identity information.

18. The method according to claim 17, further including sending an account activation message to a client device of the individual.

19. The method according to claim 17, further including storing account information in a partitioned database, each partition of the database storing account information related to customers of a different financial institution.

20. (canceled)

21. A system for performing an action in a branchless banking environment, the system including one or more electronic processing devices that:
receive an identifier associated with an individual from an agent terminal via a communications network;
receive authentication information supplied by the individual from the agent terminal;
retrieve identity information from a database using the identifier;
authenticate the individual using the authentication information and the identity information retrieved from the database; and
perform an action in response to successful authentication, the action including at least one of:
establishing an account on behalf of the individual using the identity information; and
performing a transaction on behalf of the individual.

22. The system according to claim 21, wherein the electronic processing device is configured to serve multiple tenants.

23. (canceled)

24. The system according to claim 21, wherein the system further includes a partitioned database for storing customer account information, each partition of the database storing customer account information associated with a particular financial institution and wherein the electronic processing device is in communication with the partitioned database.

25. (canceled)

26. (canceled)

27. The system according to claim 21, wherein the authentication information includes at least one of:
a one-time password (OTP); and
biometric information associated with the individual;
wherein the biometric information is scanned by a biometric reader device in communication with the agent terminal.

28. (canceled)

29. The system according to claim 21, wherein the identifier received from the agent terminal includes at least one of:
a unique identification number; and
a mobile phone number.

30. The system according to claim 21, wherein the identity information retrieved from the database using the at least one identifier includes at least one of:
a name;
an address;
a date of birth;
a mobile phone number;
an electronic communications address; and
biometric information.

31. (canceled)

32. (canceled)
